(19) United States
(12) Patent Application Publication
(10) Pub. No.: US 2024/0067149 A1
(43) Pub. Date: Feb. 29, 2024

(54) BRAKE SYSTEM ASSEMBLY

(71) Applicant: AUDI AG, Ingolstadt (DE)

(72) Inventor: Christopher WOLFRAM, Wurzbach (DE)

(73) Assignee: AUDI AG, Ingolstadt (DE)

(21) Appl. No.: 18/446,772

(22) Filed: Aug. 9, 2023

(30) Foreign Application Priority Data
Aug. 29, 2022 (DE) 102022121745.0

(51) Int. Cl. B60T 13/66; B60T 11/26

(52) U.S. Cl. CPC B60T 13/66; B60T 11/26; B60T 2270/82

(57) ABSTRACT

An assembly for an electrohydraulic brake system of a vehicle, including at least one brake control module which has an electronically actuated pressure supply device which, in the installed state of the assembly, is fluidically coupled to at least one wheel brake of the vehicle. The brake control module is connected to a holding device for arrangement on a vehicle body. The brake control module includes a mechanical stop device which, when the assembly is installed, is spaced apart at a distance from an adjacent vehicle component and, by interaction with the vehicle component, emits a warning signal in the event of a loss of support of the brake control module.

### FIELD

The invention relates to a brake system assembly for a vehicle.

### BACKGROUND

In addition to conventional hydraulic systems, in which braking pressure is generated via an externally actuated brake pedal, electrohydraulic external force brake systems and so-called brake-by-wire brake systems are also known.

In a hydraulic brake, the braking force is transmitted hydraulically. This means that a driver uses the brake pedal to actuate a piston in the main brake cylinder to supply brake fluid to the wheel brakes via lines and hoses and to build up brake pressure to the wheel brakes. The brake system can have an electronically controlled driver assistance system, for example an ESC brake control module, which uses sensors to detect a critical vehicle condition and ensures that the driver controls the vehicle by selectively braking individual wheels. The brake control module, which is also referred to as a brake control system, is normally positioned directly in front of the bulkhead in the direction of travel. However, it is also conceivable that it is positioned more freely in the front end package, wherein it is connected to the brake master cylinder via fluid lines.

In an electrohydraulic external force brake system, the force exerted by the foot acts only as a control signal to actuate the brake system. The hydraulic brake pressure for the wheel brakes is controlled by an electric signal. A deviation of the brake pedal from its rest position is detected by sensors, a control signal is determined therefrom and a pressure supply device of a brake control module is activated to build up the brake pressure in the wheel brakes. The electrohydraulic brake system is dependent on electrical energy and has, in particular, a hydraulic fallback level. In the event of a failure of the control unit, a direct connection between the master brake cylinder and the wheel brakes of an axle is established via valves of the pressure supply device, so that a braking force is built up by the muscular force of the driver. This requires a direct arrangement of the brake control module directly on the bulkhead of the vehicle.

So-called “brake-by-wire” brake systems are being used more and more frequently, for example in highly automated driving starting from level 3, which allows the vehicle user to be temporarily not responsible for driving and the braking of the vehicle to take place autonomously. Based on data and a large number of vehicle sensors, a control unit actuates a pressure supply device that builds up brake pressure in the braking circuits. Due to the dependency of this brake system on the functional reliability of the vehicle electronics, there is a fallback level that intervenes in the event of failure of the normal level and builds up a brake pressure. DE 10 2017 211 955 A1 describes, for example, a brake system for a vehicle, in particular a highly automated vehicle.

By mechanically decoupling the brake-by-wire brake system, the brake control modules of the respective normal and fallback levels no longer have to be mounted in a specific position in front of the driver directly on the bulkhead of the vehicle, but can be mounted more freely and easily in the front package.

A brake control module of a brake system is usually preassembled with a holding device and then installed as an assembly in the vehicle. The brake control module is connected to the vehicle body by interposing the holding device. If this holding device breaks at any point, such as at a holding arm, the freedom of movement of the brake control module is increased. The weight of the brake control module leads to an increased load on fluid connections and fluid lines. The excitations transmitted by the chassis can cause further damage, for example a breakage in the fluid lines or connections. The result is a loss of brake fluid and pressure loss at the wheel brakes. Technically, the breakage of the holding device is difficult to detect, so that a vehicle can drive for a long time unnoticed with a broken holding device, without it being detected or indicated by a vehicle system. As a consequence, however, a total failure of the brake system may possibly occur.

Brake systems are known from the prior art, which are associated with an impact device that triggers an acoustic warning signal. For example, FR 371 537 A describes a form-fitting connecting device that is connected between a valve, which is connected to a continuous brake line of railroad trains or to another warning and/or display device, and a shaft controlled by levers that pass on bumpers or knockers mounted on the track, thereby actuating the warning and/or display device.

CN 2 823 073 Y describes an opto-acoustic stop device of a brake system that prompts a vehicle user to check the brake system, in particular the brake pads. In a conventional brake system, the brake pedal can be depressed up to the lowest position due to worn brake pads. Due to the increased play of the depressed brake pedal, contact is made with the stop device. As a result, a rear end cover of an insulating sleeve of the stop device is displaced in such a way that a metal guide rod arranged in the insulating sleeve comes into contact with a metal cylinder. The metal cylinder is connected to a sound and light alarm that is triggered by the established conductive connection.

### SUMMARY

The object of the invention is to further develop a brake system assembly of a vehicle in such a way that a loss of support of the assembly can be detected quickly by simple, inexpensive and reliable means in order to substantially prevent damage to the assembly.

In a known manner, an assembly of an in particular electrohydraulic brake system for a vehicle comprises at least one brake control module which has an electronically controlled pressure supply device. The pressure supply device can in particular comprise a hydraulic block with a brake pressure control, an electric motor and a pump. The brake control module may also be referred to as a brake control system.

In the installed state of the assembly, the pressure supply device is fluidically connected to at least one wheel brake of the vehicle. The pressure supply device is coupled to the wheel brake via fluid connections and fluid lines for a brake fluid. The pressure supply device is controlled by the electronic control unit depending on data and a plurality of different vehicle sensors in order to build up brake pressure in the wheel brake.

When the assembly is installed, the brake control module is connected to the vehicle body via a holding device. The brake control module can, for example, have a housing that is screwed to the holding device with multiple screws, whereby the holding device is connected to the vehicle body, for example a side member or a bulkhead separating the engine compartment from the passenger compartment. The holding device can, for example, be designed as a strip, a U-profile, a free-form part or the like. It is conceivable that it is formed from metal or from plastic material.

According to the invention, the brake control module is connected to a mechanical stop device which, when the assembly is installed, is arranged at a distance from an adjacent vehicle component and, by interacting with the vehicle component, emits a warning signal in the event of a loss of support of the brake control module.

When the holding device is intact, the stop device is at a defined distance from the adjacent vehicle component. The distance is predetermined in the longitudinal direction of the vehicle, in the transverse direction of the vehicle and/or in the vertical direction of the vehicle. The defined distance is designed in such a way that in the event of failure of the holding device, for example due to loosening and/or breakage at any point, the stop device interacts with the in particular directly adjacent vehicle component, by repeatedly hitting or striking it, due to vibrational-mechanical excitation of the chassis during driving, such as in case of acceleration or deceleration, due to transverse dynamics such as while driving around curves and/or when driving over thresholds, potholes or the like, due to the amplified oscillations. In this case, the distance is designed as a function of an immediate environment of the assembly and under consideration of vibrational effects and tolerances. As a result, the stop device hits the adjacent vehicle component at an early stage in the event of loss of support. In this way, the movement path of the brake control module can be limited.

The vibrational excitations cause a repetition of the mechanical interaction of the stop device with the adjacent vehicle component, which serves as a resonance body and generates a repetitive acoustic signal due to the impact with the stop device, which signal is transmitted to the passenger compartment, in particular via airborne sound and/or structure-borne sound. The stop device thus serves as an impact acoustic system or sound source that triggers an indication or a warning signal about the loss of support of the assembly during driving operation. The stop device represents a monitoring device which informs a vehicle user by very simple and inexpensive means that the holding device is loose, defective and/or broken.

In an advantageous manner, the stop device generates a mechanically excited, acoustic warning signal without the use of electronic displays, optical signals or the like, which signal is a warning of permanent overload of the brake control module, fluid lines and fluid connections, thereby reducing or largely avoiding damage to the brake system.

Preferably, the stop device is force-fittingly, form-fittingly and/or integrally connected to the brake control module. The stop device can, among other things, be screwed, clamped, welded, injection-molded and/or glued to the brake control module.

According to an embodiment, the stop device has at least one stop element. The stop element serves as a stop surface, namely as a physical obstacle or a point which strikes or hits a vehicle component, in particular an immediately adjacent one, in the event of loss of support. The stop element can, for example, be formed as a strip which can be easily arranged on the brake control module at a predefined distance from the vehicle component.

Preferably, the stop element is made of a hard and/or solid material. The stop element is robust and provides low attenuation and high transmission of the acoustic impulse. The stop element can, for example, be made of plastic material and/or metal. It can, for example, be designed as a metal strip.

Preferably, the stop device is connected to a connecting element via which the brake control module is connected to the holding device. The brake control module is connected to the holding device with the interposition of a connecting element. This means that the stop device can be indirectly connected to the brake control module. The connecting element can, for example, serve as an adapter for connecting the brake control module to the holding device. A stop element is formed on the connecting element, for example, which is spaced apart from the adjacent vehicle component, for example the vehicle body, by a predetermined distance. When the holding device breaks or loosens, the stop element repeatedly hits the adjacent vehicle component due to the vibrational excitation of the vehicle and causes a knocking sound.

According to an embodiment, the brake control module is designed to build up wheel-specific brake pressures. The brake control module can be designed, for example, as an ESC unit, which can also be referred to as an ESP unit, of a conventional electrohydraulic brake system that has an electronically controlled driver assistance system. The brake control module is mechanically or fluidically connected via the pressure supply device to a brake actuation unit of the vehicle, namely to a brake booster which can be actuated by a vehicle user via a brake pedal. The ESC unit only intervenes in a braking process if the sensors detect a critical vehicle condition. In this case, the pressure supply device is actuated via electronic signals, for example to hydraulically operate only one brake caliper of a wheel brake without operating a pressure input of the master cylinder, thereby stabilizing the vehicle.

Alternatively, it is conceivable that the brake control module is formed by integrating the ESC unit with the brake booster. The combination is referred to as an integrated brake control system or brake control module.

According to an alternative embodiment, the brake control module is designed as the first brake control module active during normal operation of a “brake-by-wire” brake system, which may also be referred to as the primary brake control module. This means that the first brake control module triggers a braking process of the vehicle by actuating the pressure supply device to generate a brake pressure in the wheel brakes. In the brake-by-wire design, the mechanical decoupling of an actuator device and of an actuating device of the brake system allows independent arrangement of the brake control module at any position in the vehicle package, so that optimum use can be made of a vehicle's installation space.

Preferably, the stop device is connected to a fluid reservoir of the first brake control module. In a “brake-by-wire” brake system, the first brake control module, which is active during normal operation, is fluidically connected to a fluid reservoir for brake fluid used to generate brake pressure in the wheel brakes. A stop element can be formed or attached to or injected onto the fluid reservoir. In the event of a defective holding device or loss of bearing support of the assembly, the stop element can repeatedly make contact with an adjacent vehicle component, for example due to vehicle acceleration, thus generating a knocking noise or warning signal.

According to a preferred embodiment, the vehicle component represents a redundant, second brake control module of the “brake-by-wire” brake system, which is also referred to as a secondary brake control module. In this type of brake system, there is a fallback level. This means that the assembly comprises a redundant, second brake control module, which is connected in a communicating manner to the first brake control module and which is responsible for autonomous braking in the event of a malfunction of the first brake control module. The redundant second brake control module is installed in particular directly vertically below the first brake control module. The respective brake control modules are connected fluidically via fluid connections and fluid lines on the one hand to the fluid reservoir and on the other hand to the wheel brakes. A breakage or loosening of the holding device causes the stop device to repeatedly strike the redundant second brake control module and cause an acoustic warning signal. In particular, the stop device may repeatedly strike a housing, such as a metal housing of the redundant second brake control module.

Preferably, the vehicle component is formed as an element of the vehicle body. It is conceivable that the stop device is spaced apart by a defined distance from, for example, a suspension strut dome, a longitudinal member, the end wall of the engine compartment, a connecting strut or another part of the vehicle body. In the event of a loss of support of the assembly or breakage of the holding device, the brake control module has increased freedom of movement. Due to the deflection of the brake control module, the stop device repeatedly hits or impacts on the vehicle body. This is robustly designed and mainly formed of metal, so that it acts as a resonance body. As a result, the acoustic warning signal is successfully transmitted into the passenger compartment.

### BRIEF DESCRIPTION OF THE FIGURES

Further advantages and possible applications of the present invention are apparent from the following description in conjunction with the exemplary embodiment shown in the drawing.

In the drawing:

FIG. 1 shows a perspective view of a brake system assembly known from the prior art, obliquely from the front; and

FIG. 2 shows a side view of a brake system assembly according to the invention.

### DETAILED DESCRIPTION

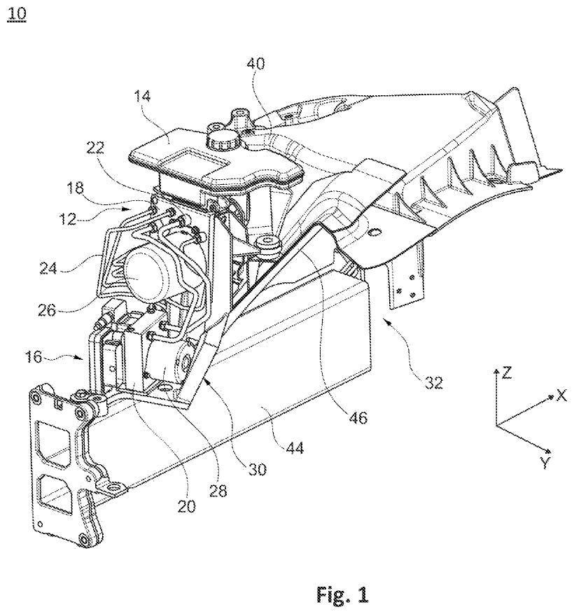

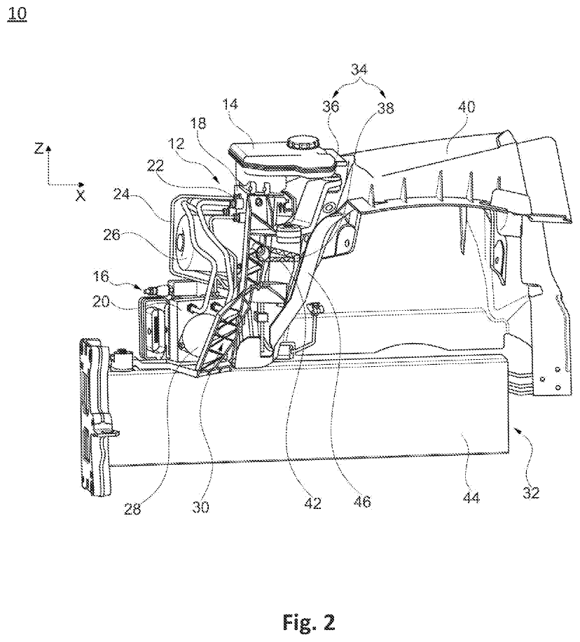

In FIG. 1 and FIG. 2, an assembly of a “brake-by-wire” brake system, designated overall by the reference numeral 10, is shown in the installed state.

The assembly 10 includes a first brake control module 12 fluidically connected to a fluid reservoir 14 for a brake fluid. The fluid reservoir 14 is generally installed in a vertical direction Z above the first brake control module 12.

The assembly 10 comprises a second brake control module 16, which is presently arranged below the first brake control module 12 in the vertical direction Z of the vehicle. The two brake control modules 12, 16 are connected to each other so that they can communicate. In normal operation of the brake-by-wire brake system, the first brake control module 12, also referred to as the primary brake control module, is used to actively build up brake pressure in the brake system. The second brake control module 16, also referred to as the secondary brake control module, forms a redundant fallback level that intervenes and builds up brake pressure in the event of failure of the first brake control module 12.

In the present case, the first brake control module 12 has a first housing 18 and the second brake control module 16 has a second housing 20. The housings 18, 20 are formed with fluid connections 22 to which fluid lines 24 are connected. The housings 18, 20 are fluidically connected on the one hand to the fluid reservoir 14 and, on the other hand, to brake circuits of the wheel brakes of the vehicle, which are not shown here. The brake control modules 12, 16 are arranged vertically below the fluid reservoir 14 for venting the brake system and for reducing intake resistances.

Integrated in the housing 18 of the first brake control module 12 is an electronic control unit, not shown here, which during normal operation of the brake system controls a brake pressure control, also not shown, arranged in the brake control module 12, which in turn controls an electro-mechanical actuator 26 of the brake control module 12 in order to pressurize the brake fluid in the brake circuits of the wheel brakes. The electronic control unit, the brake pressure control and/or the actuator 26 are arranged in particular in the first housing 18.

In the event of a failure of the first brake control module 12, the second brake control module 16 takes over the braking function. The second brake control module 16 also has an electronic control unit, also not shown here, for actuating the brake pressure control device arranged in the brake control module 16, which in turn controls an actuator 28 to build up a brake pressure. The electronic control unit, the brake pressure control device and/or the actuator 28 of the second brake control module 16 are arranged in particular in the second housing 20.

In FIG. 1 and FIG. 2, the first brake control module 12 and the second brake control module 16 or their respective housings 18, 20 are connected to a vehicle body 32 via a holding device 30. The first brake control module 12 is, for example, screwed with multiple screws to the holding device 30, which in turn is connected to the vehicle body 32. The second brake control module 16 is supported via its housing 20 on a longitudinal member 44 of the vehicle body 32 with the interposition of the holding device 30.

In FIG. 1, a case of failure of the holding device 30, for example due to a breakage at any location, is represented by several lightning-shaped signs.

In FIG. 2, the stop device 34 of the assembly 10 according to the invention can be clearly seen. In the present case, the stop device 34 is connected to the first brake control module 12. The stop device 34 serves for detecting a failure of the holding device 30 or for detecting a loss of support of the assembly 10.

The stop device 34 is presently indirectly and directly connected to the first brake control module 12. The stop device 34 has stop elements 36, 38. In the intact state of the holding device 30, the stop elements 36, 38 have a defined distance from the vehicle body 32 in the longitudinal direction X of the vehicle, in the transverse direction Y of the vehicle and/or in the vertical direction Z of the vehicle.

In the defective state of the holding device 30 or in the event of a loss of support of the assembly 10, the stop device 34 is presently designed in such a way that at least one of the stop elements 36, 38 repeatedly strikes against the vehicle body 32, which serves as a resonance body, for example, due to the amplified vibrations of the first brake control module 12 in the longitudinal direction X of the vehicle, in the transverse direction Y of the vehicle and/or in the vertical direction Z of the vehicle. The mechanical interaction of the stop elements 36, 38 with the vehicle body 32 causes an acoustic signaling, namely the emission of a mechanical, acoustic warning signal, which is transmitted in particular via airborne sound and/or structure-borne sound into the passenger compartment. The stop elements 36, 38 are preferably formed of metal and/or hard plastic material, so that the acoustic impulse penetrates the passenger compartment as unattenuated as possible.

For example, the stop element 36 of the stop device 34 is materially connected to the fluid reservoir 14. The stop element 36 is formed, for example, of plastic material or is injection-molded as a metal element into the fluid reservoir 14. In the longitudinal direction of the vehicle X it is presently arranged at a defined distance from a spring strut dome 40 of the vehicle body 32. In the event of failure of the holding device, the distance between the spring strut dome 40 and the stop element 36 is reduced, for example, by acceleration of the vehicle in the longitudinal direction X of the vehicle, and the stop element 36 hits or strikes the spring strut dome 40 repeatedly.

In the present case, the first brake control module 12 is connected to the holding device 30 with the interposition of a connecting element 42. The stop element 38 is presently formed on the connecting element 42. It can, for example, be formed by a metal strip or the like. In the present case, the stop element 38 is arranged at a predetermined distance from the vehicle body 32 in the longitudinal direction X of the vehicle and at a distance from a connecting strut 46 of the vehicle body 32 in the vertical direction Z of the vehicle. When the holding device 30 breaks or loosens, the stop element 38 repeatedly strikes the vehicle body 32 and/or the connecting strut 46 due to the vibrational excitation of the vehicle and causes a knocking sound.

1. A brake system assembly of a vehicle, comprising at least one brake control module which has an electronically controlled pressure supply device which, in the installed state of the assembly, is fluidically coupled to at least one wheel brake of the vehicle, and wherein the brake control module is connected to a holding device for arrangement on a vehicle body,
wherein the brake control module has a mechanical stop device which, in the installed state of the assembly, is spaced apart at a distance from an adjacent vehicle component and, by interaction with the vehicle component, outputs a warning signal in the event of a loss of support of the brake control module.

2. The brake assembly according to claim 1, wherein the stop device is connected to the brake control module in a force-fitting, form-fitting and/or integral manner.

3. The brake assembly according to claim 1, wherein the stop device has at least one stop element.

4. The brake assembly according to claim 3, wherein the stop element is formed of a hard and/or solid material.

5. The brake according to claim 1, wherein the stop device is arranged on a connecting element via which the brake control module is connected to the holding device.

6. The brake assembly according to claim 1, wherein the brake control module is designed to build up individual wheel brake pressures.

7. The brake assembly according to claim 1, wherein the brake control module is designed as the first brake control module which is active during normal operation of a brake-by-wire brake system.

8. The brake assembly according to claim 7, wherein the stop device is connected to a fluid reservoir of the first brake control module.

9. The brake assembly according to claim 7, wherein the vehicle component is designed as a redundant, second brake control module.

10. The brake assembly according to claim 1, wherein the vehicle component is formed as an element of the vehicle body.

11. The brake assembly according to claim 2, wherein the stop device has at least one stop element.

12. The brake according to claim 2, wherein the stop device is arranged on a connecting element via which the brake control module is connected to the holding device.

13. The brake according to claim 3, wherein the stop device is arranged on a connecting element via which the brake control module is connected to the holding device.

14. The brake according to claim 4, wherein the stop device is arranged on a connecting element via which the brake control module is connected to the holding device.

15. The brake assembly according to claim 2, wherein the brake control module is designed to build up individual wheel brake pressures.

16. The brake assembly according to claim 3, wherein the brake control module is designed to build up individual wheel brake pressures.

17. The brake assembly according to claim 4, wherein the brake control module is designed to build up individual wheel brake pressures.

18. The brake assembly according to claim 5, wherein the brake control module is designed to build up individual wheel brake pressures.

19. The brake assembly according to claim 2, wherein the brake control module is designed as the first brake control module which is active during normal operation of a brake-by-wire brake system.

20. The brake assembly according to claim 3, wherein the brake control module is designed as the first brake control module which is active during normal operation of a brake-by-wire brake system.
